(19) United States
(12) Patent Application Publication
(10) Pub. No.: US 2007/0160137 A1
(43) Pub. Date: Jul. 12, 2007

(54) Error resilient mode decision in scalable video coding

(75) Inventors: Yi Guo, Heifei (CN); Ye-Kui Wang, Tampere (FI); Houqiang Li, Heifei (CN)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/651,420

(22) Filed: Jan. 8, 2007

Related U.S. Application Data
(60) Provisional application No. 60/757,744, filed on Jan. 9, 2006.

(51) Int. Cl. H04B 1/66; H04N 11/04

(52) U.S. Cl. 375/240.1; 375/240.24; 375/240.27

(57) ABSTRACT

An encoder for use in scalable video coding has a mechanism to perform macroblock mode selection for the enhancement layer pictures. The mechanism includes a distortion estimator for each macroblock that reacts to channel errors such as packet losses or errors in video segments affected by error propagation; a Lagrange multiple selector for selecting a weighting factor according to estimated or signaled channel error rate, and a mode decision module or algorithm to choose the optimal mode based on encoding parameters. The mode decision module is configured to select the coding mode based on a sum of the estimated coding distortion and the estimated coding rate multiplied by the weighting factor.

This patent application is based on and claims priority to U.S. Patent Application Ser. No. 60/757,744, filed Jan. 9, 2006, and assigned to the assignee of the present invention.

### FIELD OF THE INVENTION

The present invention relates generally to scalable video coding and, more particularly, to error resilience performance of the encoded scalable streams.

### BACKGROUND OF THE INVENTION

Video compression standards have been developed over the last decades and form the enabling technology for today's digital television broadcasting systems. The focus of all current video compression standards lies on the bit stream syntax and semantics, and the decoding process. Also existing are non-normative guideline documents, commonly known as test models that describe encoder mechanisms. They consider specifically bandwidth requirements and data transmission rate requirements. Storage and broadcast media targeted by the former development include digital storage media such as DVD (digital versatile disc) and television broadcasting systems such as digital satellite (e.g. DVB-S: digital video broadcast—satellite), cable (e.g. DVB-C: digital video broadcast—cable), and terrestrial (e.g. DVB-T: digital video broadcast—terrestrial) platforms. Efforts have been concentrated on an optimal bandwidth usage, in particular to DVB-T standard, where there is insufficient radio frequency spectrum available. However, these storage and broadcast media essentially guarantee a sufficient end-to-end quality of service. Consequently, quality-of-service aspects have only been considered with minor importance.

In recent years, however, packet-switched data communication networks such as the Internet have increasingly gained importance for transfer/broadcast of multimedia contents including of course digital video sequences. In principle, packet-switched data communication networks are subjected to limited end-to-end quality of service in data communications comprising essentially packet erasures, packet losses, and/or bit failures, which have to be dealt with to ensure failure free data communications. In packet-switched networks, data packets may be discarded due to buffer overflow at intermediate nodes of the network, may be lost due to transmission delays, or may be rejected due to queuing misalignment on receiver side.

Moreover, wireless packet-switched data communication networks with considerable data transmission rates enabling transmission of digital video sequences are available and the market of end users having access thereto is developing. It is anticipated that such wireless networks form additional bottlenecks in end-to-end quality of service. Especially, third generation public land mobile networks such as UMTS (Universal Mobile Telecommunications System) and improved 2nd generation public land mobile networks such as GSM (Global System for Mobile Communications) with GPRS (General Packet Radio Service) and/or EDGE (Enhanced Data for GSM Evolution) capability are supposed for digital video broadcasting. Nevertheless, limited end-to-end quality of service can be also experienced in wireless data communications networks for instance in accordance with any IEEE (Institute of Electrical & Electronics Engineers) 802.xx standard.

In addition, video communication services now become available over wireless circuit switched services, e.g. in the form of 3G.324M video conferencing in UMTS networks. In this environment, the video bit stream may be exposed to bit errors and to erasures.

The invention presented is suitable for video encoders generating video bit streams to be conveyed over all mentioned types of networks. For the sake of simplification, but not limited thereto, following embodiments are focused henceforth on the application of error resilient video coding for the case of packet-switched erasure prone communication.

With reference to present video encoding standards employing predictive video encoding, errors in a compressed video (bit-) stream, for example in the form of erasures (through packet loss or packet discard) or bit errors in coded video segments, significantly reduce the reproduced video quality. Due to the predictive nature of video, where the decoding of frames depends on frames previously decoded, errors may propagate and amplify over time and cause seriously annoying artifacts. This means that such errors cause substantial deterioration in the reproduced video sequence. Sometimes, the deterioration is so catastrophic that the observer does not recognize any structures in a reproduced video sequence.

Decoder-only techniques that combat such error propagation and are known as error concealment help to mitigate the problem somewhat, but those skilled in the art will appreciate that encoder-implemented tools are required as well. Since the sending of complete intra frames leads to large picture sizes, this well-known error resilience technique is not appropriate for low delay environments such as conversational video transmission.

Ideally, a decoder would communicate to the encoder areas in the reproduced picture that are damaged, so to allow the encoder to repair only the affected area. This, however, requires a feedback channel, which in many applications is not available. In other applications, the round-trip delay is too long to allow for a good video experience. Since the affected area (where the loss related artifacts are visible) normally grows spatially over time due to motion compensation, a long round trip delay leads to the need of more repair data which, in turn, leads to higher (average and peak) bandwidth demands. Hence, when round trip delays become large, feedback-based mechanisms become much less attractive.

Forward-only repair algorithms do not rely on feedback messages, but instead select the area to be repaired during the mode decision process, based only on knowledge available locally at the encoder. Of these algorithms, some modify the mode decision process such to make the bit stream more robust, by placing non-predictively (intra) coded regions in the bit stream even if they are not optimal from the rate-distortion model point of view. This class of mode decision algorithms is commonly referred to as intra refresh. In most video codecs, the smallest unit which allows an independent mode decision is known as a macroblock. Algorithms that select individual macroblocks for intra coding so to preemptively combat possible transmission errors are known as intra refresh algorithms.

Random Intra refresh (RIR) and cyclic Intra refresh (CIR) are well known methods and used extensively. In Random Intra refresh (RIR), the Intra coded macroblocks are selected randomly from all the macroblocks of the picture to be coded, or from a finite sequence of pictures. In accordance with cyclic Intra refresh (CIR), each macroblock is Intra updated at a fixed period, according to a fixed “update pattern”. Neither algorithm takes the picture content or the bit stream properties into account.

The test model developed by ISO/IEC JTC1/SG29 to show the performance of the MPEG-4 Part 2 standard contains an algorithm known as Adaptive Intra refresh (AIR). Adaptive Intra refresh (AIR) selects those macroblocks, which have a largest sum of absolute difference (SAD), calculated between the spatially corresponding, motion compensated macroblock in the reference picture buffer.

The test model developed by the Joint Video Team (JVT) to show the performance of the ITU-T Recommendation H.264 contains a high complexity macroblock selection method that places intra macroblocks according to the rate-distortion characteristics of each macroblock, and it is called Loss Aware Rate Distortion Optimization (LA-RDO). LA-RDO algorithm simulates a number of decoders at the encoder and each simulated decoder independently decodes the macroblock at the given packet loss rate. For more accurate results, simulated decoders also apply error-concealment if the macroblock is found to be lost. The expected distortion of a macroblock is averaged over all the simulated decoders and this average distortion is used for mode selection. LA-RDO generally gives good performance, but it is not feasible for many implementations as the complexity of the encoder increases significantly due to simulating a potentially large number of decoders.

Another method with high complexity is known as Recursive Optimal per-pixel Estimate (ROPE). ROPE is believed to quite accurately predict the distortion if the macroblock is lost. However, similar to LA-RDO, ROPE has high complexity, because it needs to make computations on pixel level.

The scalable video coding (SVC) is currently being developed as an extension of the H.264/AVC standard. SVC can provide scalable video bitstreams. A portion of a scalable video bitstream can be extracted and decoded with a degraded playback visual quality. A scalable video bitstream contains a non-scalable base layer and one or more enhancement layers. An enhancement layer may enhance the temporal resolution (i.e. the frame rate), the spatial resolution, or simply the quality of the video content represented by the lower layer or part thereof. In some cases, data of an enhancement layer can be truncated after a certain location, even at arbitrary positions, and each truncation position can include some additional data representing increasingly enhanced visual quality. Such scalability is referred to as fine-grained (granularity) scalability (FGS). In contrast to FGS, the scalability provided by a quality enhancement layer that does not provide fined-grained scalability is referred to as coarse-grained scalability (CGS). Base layers can be designed to be FGS scalable as well; however, no current video compression standard or draft standard implements this concept.

The mechanism to provide temporal scalability in the latest SVC specification is not more than what is in H.264/AVC standard. Herein the so-called hierarchical B pictures coding structure is used. This feature is fully supported by AVC and the signaling part can be done by using the sub-sequence related supplemental enhancement information (SEI) messages.

For mechanisms that provide spatial and CGS scalabilities, the conventional layered coding technique similar to that in earlier standards is used with some new inter-layer prediction methods. For example, data that could be inter-layer predicted includes intra texture, motion and residual. The so-called single-loop decoding is enabled by a constrained intra texture prediction mode, whereby the inter-layer intra texture prediction is only applied to the enhancement-layer macroblocks for which the corresponding block of the base layer is located inside the intra macroblocks, while those intra macroblocks in the base layer use constrained intra mode (i.e. the constrained_intra_pred_flag is 1) as specified by H.264/AVC.

In single-loop decoding, the decoder needs to perform motion compensation and full picture reconstruction only for the scalable layer desired for playback, hence the decoding complexity is greatly reduced. The spatial scalability has been generalized to enable the base layer to be a cropped and zoomed version of the enhancement layer.

In SVC, the quantization and entropy coding modules are adjusted to provide FGS capability. The coding mode is called as progressive refinement, wherein successive refinements of the transform coefficients are encoded by repeatedly decreasing the quantization step size and applying a “cyclical” entropy coding akin to sub-bitplane coding.

The scalable layer structure in the current draft SVC standard is characterized by three variables, referred to as temporal_level, dependency_id and quality_level. These variables are signaled in the bit stream or can be derived according to the specification. The temporal_level variable is used to indicate the temporal scalability or frame rate. A layer comprising pictures of a smaller temporal_level value has a smaller frame rate than a layer comprising pictures of a larger temporal_level. The dependency_id variable is used to indicate the inter-layer coding dependency hierarchy. At any temporal location, a picture of a smaller dependency_id value may be used for inter-layer prediction for coding of a picture with a larger dependency_id value. The quality_level (Q) variable is used to indicate FGS layer hierarchy. At any temporal location and with identical dependency_id value, an FGS picture with quality_level value equal to Q uses the FGS picture or the base quality picture (i.e., the non-FGS picture when Q-1=0) with quality_level value equal to Q-1 for inter-layer prediction.

FIG. 1 depicts a temporal segment of an exemplary scalable video stream with the displayed values of the three variables discussed above. It should be noted that the time values are relative, i.e. time=0 does not necessarily mean the time of the first picture in display order in the bit stream. A typical prediction reference relationship of the example is shown in FIG. 2, where solid arrows indicate the inter-layer prediction reference relationship in the horizontal direction, and dashed block arrows indicate the inter-layer prediction reference relationship. The pointed-to instance uses the instance in the other direction for prediction reference.

A layer is defined as the set of pictures having identical values of temporal_level, dependency_id and quality_level, respectively. To decode and playback an enhancement layer, typically the lower layers including the base layer should also be available, because the lower layers may be directly or indirectly used for inter-layer prediction in the decoding of the enhancement layer. For example, in FIGS. 1 and 2, the pictures with (t, T, D, Q) equal to (0, 0, 0, 0) and (8, 0, 0, 0) belong to the base layer, which can be decoded independently of any enhancement layers. The picture with (t, T, D, Q) equal to (4, 1, 0, 0) belongs to an enhancement layer that doubles the frame rate of the base layer; the decoding of this layer needs the presence of the base layer pictures. The pictures with (t, T, D, Q) equal to (0, 0, 0, 1) and (8, 0, 0, 1) belong to an enhancement layer that enhances the quality and bit rate of the base layer in the FGS manner; the decoding of this layer also needs the presence of the base layer pictures.

In scalable video coding, when encoding a macroblock in an enhancement layer picture, the traditional macroblock coding modes in single-layer coding as well as new macroblock coding modes may be used. New macroblock coding modes use inter-layer prediction. Similar to that in single-layer coding, the macroblock mode selection in scalable video coding also affects the error resilience performance of the encoded bitstream. Currently, there is no mechanism to perform macroblock mode selection in scalable video coding that can make the encoded scalable video stream resilient to the target loss rate.

### SUMMARY OF THE INVENTION

The present invention provides a mechanism to perform macroblock mode selection for the enhancement layer pictures in scalable video coding so as to increase the reproduced video quality under error prone conditions. The mechanism comprises a distortion estimator for each macroblock, a Lagrange multiplier selector and a mode decision algorithm for choosing the optimal mode.

Thus, the first aspect of the present invention is a method of scalable video coding for coding video segments including a plurality of base layer pictures and enhancement layer pictures, wherein each enhancement layer picture comprises a plurality of macroblocks arranged in one or more layers and wherein a plurality of macroblock coding modes are arranged for coding a macroblock in the enhancement layer picture subject to coding distortion. The method comprises estimating the coding distortion affecting reconstructed video segments in different macroblock coding modes according to a target channel error rate; determining a weighting factor for each of said one or more layers, wherein said selecting is also based on an estimated coding rate multiplied by the weighting factor; and selecting one of the macroblock coding modes for coding the macroblock based on the estimated coding distortion.

According to the present invention, the selecting is determined by a sum of the estimated coding distortion and the estimated coding rate multiplied by the weighting factor. The distortion estimation also includes estimating an error propagation distortion, and packet losses to the video segments.

According to the present invention, the target channel error rate comprises an estimated channel error rate and/or a signaled channel error rate.

Where the target channel error rate for a scalable layer is different from another scalable layer, the distortion estimation takes into account the different target channel error rates. The weighting factor is also determined based on the different target channel error rates. The estimation of the error propagation distortion is based on the different target channel error rates.

The second aspect of the present invention is a scalable video encoder for coding video segments including a plurality of base layer pictures and enhancement layer pictures, wherein each enhancement layer picture comprises a plurality of macroblocks arranged in one or more layers and wherein a plurality of macroblock coding modes are arranged for coding a macroblock in the enhancement layer picture subject to coding distortion. The encoder comprises a distortion estimator for estimating the coding distortion affecting reconstructed video segments in different macroblock coding modes according to a target channel error rate; a weighting factor selector for determining a weighting factor for each of said one or more layers, based on an estimated coding rate multiplied by the weighting factor; and a mode decision module for selecting one of the macroblock coding modes for coding the macroblock based on the estimated coding distortion. The mode decision module is configured to select the coding mode based on a sum of the estimated coding distortion and the estimated coding rate multiplied by the weighting factor.

The third aspect of the present invention is a software application product comprising a computer readable storage medium having a software application for use in scalable video coding for coding video segments including a plurality of base layer pictures and enhancement layer pictures, wherein each enhancement layer picture comprises a plurality of macroblocks arranged in one or more layers and wherein a plurality of macroblock coding modes are arranged for coding a macroblock in the enhancement layer picture subject to coding distortion. The software application comprises the programming codes for carrying out the method as described above.

The fourth aspect of the present invention is a video coding apparatus comprising an encoder as described above.

The fifth aspect of the present invention is an electronic device, such as a mobile terminal, having a video coding apparatus comprising an encoder as described above.

### BRIEF DESCRIPTION OF THE DRAWINGS

FIG. 1 shows a temporal segment of an exemplary scalable video stream.

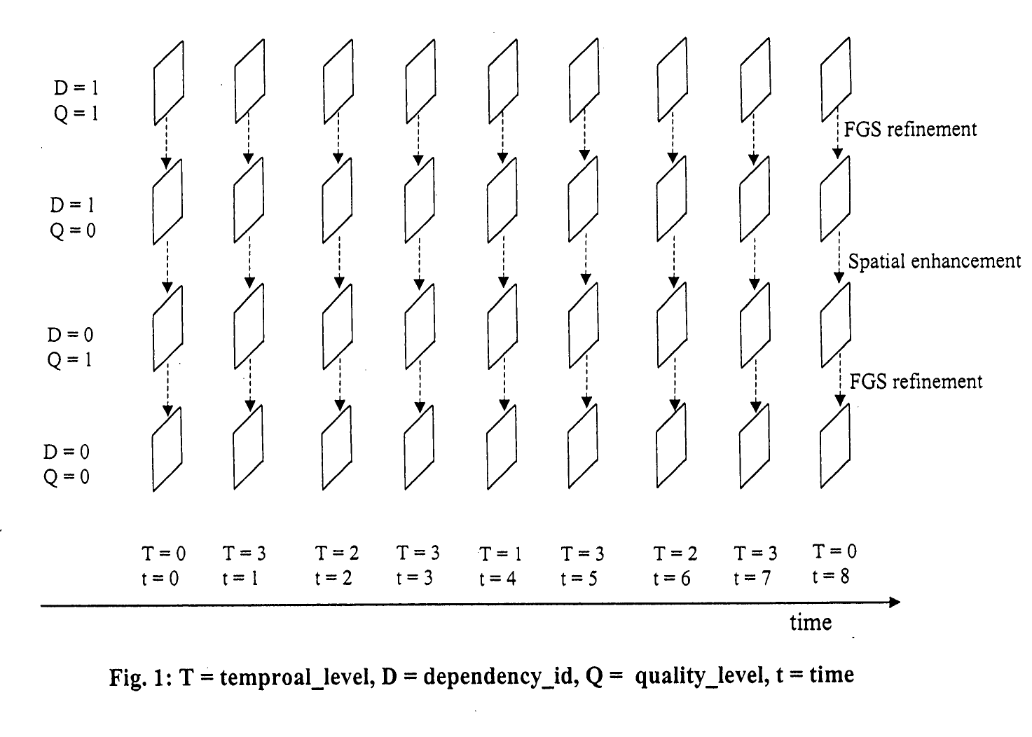

FIG. 2 shows a typical prediction reference relationship of the example depicted in FIG. 1.

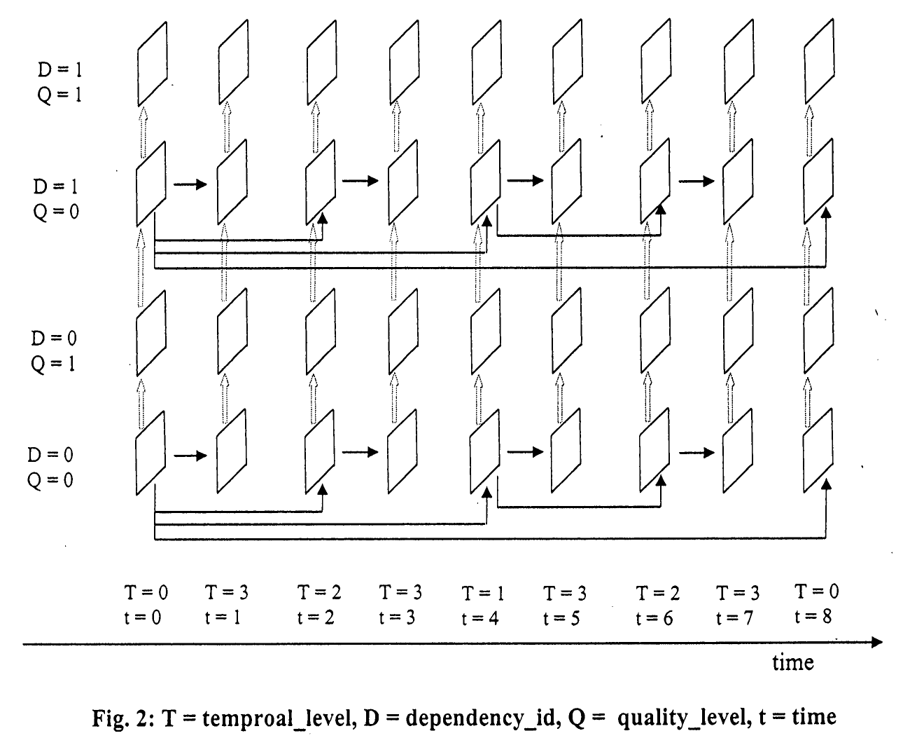

FIG. 3 illustrates the modified mode decision process in the current SVC coder structure with a base layer and a spatial enhancement layer

FIG. 4 illustrates the loss-aware rate-distortion optimized macroblock mode decision process with a base layer and a spatial enhancement layer

FIG. 5 is a flowchart illustrating the coding distortion estimation, according to the present invention.

FIG. 6 illustrates an electronic device having at least one of the scalable encoder and the scalable decoder, according to the present invention.

### DETAILED DESCRIPTION OF THE INVENTION

The present invention provides a mechanism to perform macroblock mode selection for the enhancement layer pictures in scalable video coding so as to increase the reproduced video quality under error prone conditions. The mechanism comprises the following elements:
A distortion estimator for each macroblock that reacts to channel errors such as packet losses or errors in video segments that takes potential error propagation in the reproduced video into account;
A Lagrange multiplier selector according to the estimated or signaled channel loss rates for different layers; and
A mode decision algorithm that chooses the optimal mode based on encoding parameters (i.e. all the macroblock encoding parameters that affect the number of coded bits of the macroblcok, including the motion estimation method, the quantization parameter, the macroblock partitioning method), the estimated distortion due to channel errors, and the updated Lagrange multiplier.

The macroblock mode selection, according to the present invention, is decided according to the following steps:
1. Loop over all the candidate modes, and for each candidate mode, estimate the distortion of the reconstructed macroblock resulting from the possible packet losses and the coding rate (e.g. number of bits for representing of the macroblock).
2. Calculate each mode's cost that is represented by Eq. 1, and choose the mode that gives the smallest cost.
   C=D+λ×R (1)
   In Eq. 1, C denotes the cost, D denotes the estimated distortion, R denotes the estimated coding rate, λ is the Lagrange multiplier. The Lagrange multiplier is effectively a weighting factor to the estimated coding rate for defining the cost.

The method for macroblock mode selection, according to the present invention is applicable to single-layer coding as well as multiple-layer coding.

Single Layer Method

A. Distortion Estimation

Assuming that the loss rate is pₗ, the overall distortion of the m^{th} macroblock in the n^{th} picture with the candidate coding option o is represented by:
D(n,m,o)=(1−pₗ)(Dₛ(n,m,o)+Dₑₚ_{_{—}}_{ref}(n,m,o))+pₗD_{ec}(n,m) (2)
where Dₛ(n,m,o) and Dₑₚ_{_{—}}_{ref}(n,m,o) denote the source coding distortion and the error propagation distortion respectively; and D_{ec}(n,m) denotes the error concealment distortion in case the macroblock is lost. D_{ec}(n,m) is independent of the macroblock encoding mode.

The source coding distortion Dₛ(n,m,o) is the distortion between the original signal and the error-free reconstructed signal. It can be calculated as the Mean Square Error (MSE), Sum of Absolute Difference (SAD) or Sum of Square Error (SSE). The error concealment distortion D_{ec}(n,m) can be calculated as MSE, SAD or SSE between the original signal and the error concealed signal. The used norm, MSE, SAD or SSE, shall be aligned for Dₛ(n,m,o) and D_{ec}(n,m).

For the calculation of the error propagation distortion Dₑₚ_{_{—}}_{ref}(n,m,o), a distortion map Dₑₚ for each picture on a block basis (e.g. 4×4 luma samples) is defined. Given the distortion map, Dₑₚ_{_{—}}_{ref}(n,m,o) is calculated as:

$${D}_{ep\_ref} ( n , m , o ) = {\sum }_{k = 1}^{K} {D}_{ep\_ref} ( n , m , k , o ) = {\sum }_{k = 1}^{K} {\sum }_{l = 1}^{4} {w}_{l} {D}_{ep} ( {n}_{l} , {m}_{l} , {k}_{l} , o ) \qquad ( 3 )$$

where K is the number of blocks in one macroblock, and Dₑₚ_{_{—}}_{ref}(n,m,k,o) denotes the error propagation distortion of the k^{th} block in the current macroblock. Dₑₚ_{_{—}}_{ref}(n,m,k,o) is calculated as the weighted average of the error propagation distortion ({Dₑₚ(nₗ,mₗ,kₗ,oₗ)}) of the blocks {kₗ} that are referenced by the current block. The weight wₗ of each reference block is proportional to the area that is being used as reference.

The distortion map Dₑₚ is calculated during encoding of each reference picture. It is not necessary to have the distortion map for the non-reference pictures.

For each block in the current picture, Dₑₚ(n,m,k) with the optimal coding mode o* is calculated as follows:

For an inter coded block where bi-prediction is not used, or there is only one reference picture used, the distortion map is calculated according to Eq. 4:
Dₑₚ(n,m,k)=(1−pₗ)Dₑₚ_{_{—}}_{ref}(n,m,k,o*)+pₗ(Dₑₚ_{_{—}}_{ref}(n,m,k,o*)+Dₑₚ_{_{—}}_{ref}(n,m,k)) (4)
where D_{ec}_{_{—}}_{rec}(n,m,k,o*) is the distortion between the error-concealed block and the reconstructed block, and D_{ec}_{_{—}}ₑₚ(n,m,k) is the distortion due to error concealment and the error propagation distortion in the reference picture that is used for error concealment. Assuming that the error concealment method is known, D_{ec}_{_{—}}ₑₚ(n,m,k) is calculated as the weighted average of the error propagation distortion of the blocks that are used for concealing the current block, and the weight wₗ of each reference block is proportional to the area that is being used for error concealment.

According to the present invention, the distortion map for an inter coded block where bi-prediction is used or there are two reference pictures used is calculated according to Eq. 5:

$$\begin{matrix}{D}_{ep} ( n , m , k ) = {w}_{r 0} \times ( ( 1 - {p}_{l} ) {D}_{ep\_ref \_r0} ( n , m , k , {o}^{*} ) + \\ {p}_{l} ( {D}_{ec\_rec} ( n , m , k , {o}^{*} ) + {D}_{ec\_ep} ( n , m , k ) ) ) + \\ {w}_{r 1} \times ( ( 1 - {p}_{l} ) {D}_{ep\_ref \_r1} ( n , m , k , {o}^{*} ) + \\ {p}_{l} ( {D}_{ec\_rec} ( n , m , k , {o}^{*} ) + {D}_{ec\_ep} ( n , m , k ) ) )\end{matrix} \qquad ( 5 )$$

where wᵣ₀ and wᵣ₁ are, respectively, the weights, of the two reference pictures used for bi-prediction.

For an intra coded block where no error propagation distortion is transmitted, only error concealment distortion is considered:
Dₑₚ(n,m,k)=pₗ(D_{ec}_{_{—}}_{rec}(n,m,k,o*)+D_{ec}_{_{—}}ₑₚ(n,m,k)) (6)
B. Lagrange Multiplier Selection

In error-free case where D(n,m,o) is equal to (Dₛ(n,m,o), the Lagrange multiplier is a function of the quantization parameter Q. For H.264/AVC and SVC, the value for Q is equal to (0.85×2^{Q/3-4}). However, in the case with transmission errors, a possibly different Lagrange multiplier may be needed.

The error-free Lagrange multiplier is represented by:

$${λ}_{ef} = - \frac{ⅆ {D}_{s}}{ⅆ R} \qquad ( 7 )$$

The relationship between Dₛ and R can be found in Eq. 1 and Eq. 2.

By combining Eq. 1 and Eq. 2, we get
C=(1−pₗ)(Dₛ(n,m,o)+Dₑₚ_{_{—}}_{ref}(n,m,o))+pₗD_{ec}(n,m)+λR (8)
Let the derivative of C with respect to R be zero, we get

$$λ = - ( 1 - {p}_{l} ) \frac{ⅆ {D}_{s} ( n , m , o )}{ⅆ R} = ( 1 - {p}_{l} ) {λ}_{ef} \qquad ( 9 )$$

Consequently, Eq. 1 becomes
C=(1−pₗ)(Dₛ(n,m,o)+Dₑₚ_{_{—}}_{ref}(n,m,o))+pₗD_{ec}(n,m)+(1−pₗ)λ_{ef}R (10)
Since D_{ec}(n,m) is independent of the coding mode, it can be removed from the overall cost as long as it is removed for all the candidate modes. After the term containing D_{ec}(n,m) is removed, the common coefficient (1−pₗ) can also be removed, which finally results in
C=Dₛ(n,m,o)+Dₑₚ_{_{—}}_{ref}(n,m,o)+λ_{ef}R (11)
Multi-Layer Method

In scalable coding with multiple layers, the macroblock mode decision for the base layer pictures is exactly the same as the single-layer method described above.

For a slice in an enhancement layer picture, if the syntax element base_id_plus1 is equal to 0, then no inter-layer prediction is used. In this case, the single-layer method is used, with the used loss rate being the loss rate of the current layer.

If the syntax element base_id_plus1 is not equal to 0, then new macroblock modes that use inter-layer texture, motion or residual prediction may be used. In this case, the distortion estimation and the Lagrange multiplier selection processes are presented below.

Let the current layer containing the current macroblock be lₙ, the lower layer containing the collocated macroblock used for inter-layer prediction of the current macroblock be lₙ₋₁, the further lower layer containing the macroblock used for inter-layer prediction of the collocated macroblock in lₙ₋₁ be lₙ₋₂, . . . , and the lowest layer containing an inter-layer dependent block for the current macroblock as l₀, and let the loss rates be p_{l,n}, p_{l,n-1}, . . . , p_{l,0}, respectively. For a current slice that may use inter-layer prediction (i.e. the syntax element base_id_plus1is not equal to 0), it is assumed that the current-layer macroblock would be decoded only if the current macroblock and all the dependent lower-layer blocks are received, otherwise the slice is concealed. For a slice that does not use inter-layer prediction (i.e. the syntax element base_id_plus1 is equal to 0), the current macroblock would be decoded as long as it is received.
A. Distortion Estimation The overall distortion of the m^{th} macroblock in the n^{th} picture in layer lₙ with the candidate coding option o is represented by:

$$\begin{matrix}D ( n , m , o ) = ( {\prod }_{i = 0}^{n} ( 1 - {p}_{l , i} ) ) ( {D}_{s} ( n , m , o ) + {D}_{ep\_ref} ( n , m , o ) ) + \\ ( 1 - {\prod }_{i = 0}^{n} ( 1 - {p}_{l , i} ) ) {D}_{ec} ( n , m )\end{matrix} \qquad ( 12 )$$

where Dₛ(n,m,o) and D_{ec}(n,m) are calculated in the same manner as that in the single-layer method. Given the distortion map of the reference picture in the same layer or in the lower layer (for inter-layer texture prediction), Dₑₚ_{_{—}}_{ref}(n,m,o) is calculated using Eq. 3.

The distortion map is derived as presented below. When the current layer is of a higher spatial resolution, the distortion map of the lower layer lₙ₋₁, is first up-sampled. For example, if the resolution is changed by a factor of 2 for both the width and the height, then each value in the distortion map is up-sampled to be a 2 by 2 block of identical values.

a) Macroblock Modes Using Inter-layer Intra Texture Prediction

Inter-layer intra texture prediction uses the reconstructed lower layer macroblock as the prediction for the current macroblock in the current layer. In JSVM (Joint Scalable Video Model), this coding mode is called Intra_Base macroblock mode. In this mode, distortion can be propagated from the lower layer used for inter-layer prediction. Then the distortion map of the k^{th} block in the current macroblock is

$$\begin{matrix}{D}_{ep} ( n , m , k ) = ( {\prod }_{i = 0}^{n} ( 1 - {p}_{l , i} ) ) {D}_{ep\_ref} ( n , m , k , {o}^{*} ) + \\ ( 1 - {\prod }_{i = 0}^{n} ( 1 - {p}_{l , i} ) ) ( {D}_{ec\_rec} ( n , m , k , {o}^{*} ) + {D}_{ec\_ep} ( n , m , k ) )\end{matrix} \qquad ( 13 )$$

Note that Dₑₚ_{_{—}}_{ref}(n,m,k,o) is the distortion map of the k^{th} block in the collocated macroblock in the lower layer lₙ₋₁. D_{ec}_{_{—}}_{rec}(n,m,k,o) and D_{ec}_{_{—}}ₑₚ(n,m,k) are calculated in the same manner as that in the single-layer method.
b) Macroblock Modes Using Inter-layer Motion Prediction

In JSVM, two macroblock modes employ inter-layer motion prediction, the base layer mode and the quarter pel refinement mode. If the base layer mode is used, then the motion vector field, the reference indices and the macroblock partitioning of the lower layer are used for the corresponding macroblock in the current layer. If the macroblock is decoded, it uses the reference picture in the same layer for inter prediction. Then for a block that uses inter-layer motion prediction and does not use bi-prediction, the distortion map of the k^{th} block in the current macroblock is

$$\begin{matrix}{D}_{ep} ( n , m , k ) = ( {\prod }_{i = 0}^{n} ( 1 - {p}_{l , i} ) ) {D}_{ep\_ref} ( n , m , k , {o}^{*} ) + \\ ( 1 - {\prod }_{i = 0}^{n} ( 1 - {p}_{l , i} ) ) ( {D}_{ec\_rec} ( n , m , k , {o}^{*} ) + {D}_{ec\_ep} ( n , m , k ) )\end{matrix} \qquad ( 14 )$$

For a block that uses inter-layer motion prediction and also uses bi-prediction, the distortion map of the k^{th} block in the current macroblock is

$$\begin{matrix}{D}_{ep} ( n , m , k ) = {w}_{r 0} \times ( ( {\prod }_{i = 0}^{n} ( 1 - {p}_{l , i} ) ) {D}_{ep\_ref \_r0} ( n , m , k , {o}^{*} ) + \\ ( 1 - {\prod }_{i = 0}^{n} ( 1 - {p}_{l , i} ) ) ( {D}_{ec\_rec} ( n , m , k , {o}^{*} ) + {D}_{ec\_ep} ( n , m , k ) ) ) + \\ {w}_{r 1} \times ( ( {\prod }_{i = 0}^{n} ( 1 - {p}_{l , i} ) ) {D}_{ep\_ref \_r1} ( n , m , k , {o}^{*} ) + \\ ( 1 - {\prod }_{i = 0}^{n} ( 1 - {p}_{l , i} ) ) ( {D}_{ec\_rec} ( n , m , k , {o}^{*} ) + {D}_{ec\_ep} ( n , m , k ) ) )\end{matrix} \qquad ( 15 )$$

Note that Dₑₚ_{_{—}}_{ref}(n,m,k,o*) is the distortion map of the k^{th} block in the collocated macroblock in the reference picture in the same layer lₙ. D_{ec}_{_{—}}_{rec}(n,m,k,o) and D_{ec}_{_{—}}ₑₚ(n,m,k) are calculated in the same manner as that in the single-layer method.

The quarter pel refinement mode is used only if the lower layer represents a layer with a reduced spatial resolution relative to the current layer. In this mode, the macroblock partitioning as well as the reference indices and motion vectors are derived in the same manner as that for the base layer mode, the only difference is that the motion vector refinement is additionally transmitted and added to the derived motion vectors. Therefore, Eqs. 14 and 15 can also be used for deriving the distortion map in this mode because the motion refinement is included in the resulting motion vector.

c) Macroblock Modes Using Inter-Layer Residual Prediction

In inter-layer residual prediction, the coded residual of the lower layer is used as prediction for the residual of the current layer and the difference between the residual of the current layer and the residual of the lower layer is coded. If the residual of the lower layer is received, there will be no error propagation due to residual prediction. Therefore, Eqs. 14 and 15 are used to derive the distortion map for a macroblock mode using inter-layer residual prediction.

d) Macroblock Modes not Using Inter-Layer Prediction

For an inter coded block where bi-prediction is not used, we have

$$\begin{matrix}{D}_{ep} ( n , m , k ) = ( {\prod }_{i = 0}^{n} ( 1 - {p}_{l , i} ) ) {D}_{ep\_ref} ( n , m , k , {o}^{*} ) + \\ ( 1 - {\prod }_{i = 0}^{n} ( 1 - {p}_{l , i} ) ) ( {D}_{ec\_rec} ( n , m , k , {o}^{*} ) + {D}_{ec\_ep} ( n , m , k ) )\end{matrix} \qquad ( 16 )$$

For an inter coded block where bi-prediction is used:

$$\begin{matrix}{D}_{ep} ( n , m , k ) = {w}_{r 0} \times ( ( {\prod }_{i = 0}^{n} ( 1 - {p}_{l , i} ) ) {D}_{ep\_ref \_r0} ( n , m , k , {o}^{*} ) + \\ ( 1 - {\prod }_{i = 0}^{n} ( 1 - {p}_{l , i} ) ) ( {D}_{ec\_rec} ( n , m , k , {o}^{*} ) + {D}_{ec\_ep} ( n , m , k ) ) ) + \\ {w}_{r 1} \times ( ( {\prod }_{i = 0}^{n} ( 1 - {p}_{l , i} ) ) {D}_{ep\_ref \_r1} ( n , m , k , {o}^{*} ) + \\ ( 1 - {\prod }_{i = 0}^{n} ( 1 - {p}_{l , i} ) ) ( {D}_{ec\_rec} ( n , m , k , {o}^{*} ) + {D}_{ec\_ep} ( n , m , k ) ) )\end{matrix} \qquad ( 15 )$$

For an intra coded block:

$${D}_{ep} ( n , m , k ) = ( 1 - {\prod }_{i = 0}^{n} ( 1 - {p}_{l , i} ) ) ( {D}_{ec\_rec} ( n , m , k , {o}^{*} ) + {D}_{ec\_eq} ( n , m , k ) ) \qquad ( 18 )$$

The elements in Eq. 16 to Eq. 18 are calculated the same way as in Eqs. 4 to 6.

B. Lagrange Multiplier Selection

By combining Eqs. 1 and 12, we get

$$C = ( {\prod }_{i = 0}^{n} ( 1 - {p}_{l , i} ) ) ( {D}_{s} ( n , m , o ) + {D}_{ep\_ref} ( n , m , o ) ) + ( 1 - {\prod }_{i = 0}^{n} ( 1 - {p}_{l , i} ) ) {D}_{ec} ( n , m ) + λ R \qquad ( 19 )$$

Let the derivative of C with respect to R be zero, we get

$$λ = - ( {\prod }_{i = 0}^{n} ( 1 - {p}_{l , i} ) ) \frac{ⅆ {D}_{s} ( n , m , o )}{ⅆ R} = ( {\prod }_{i = 0}^{n} ( 1 - {p}_{l , i} ) ) {λ}_{ef} \qquad ( 20 )$$

Consequently, Eq. 1 becomes

$$C = ( {\prod }_{i = 0}^{n} ( 1 - {p}_{l , i} ) ) ( {D}_{s} ( n , m , o ) + {D}_{ep\_ref} ( n , m , o ) ) + ( 1 - {\prod }_{i = 0}^{n} ( 1 - {p}_{l , i} ) ) {D}_{ec} ( n , m ) + ( {\prod }_{i = 0}^{n} ( 1 - {p}_{l , i} ) ) {λ}_{ef} R \qquad ( 21 )$$

Here D_{ec}(n,m) may be dependent on the coding mode, since the macroblock may be concealed even it is received, while the decoder may utilize the known coding mode to use a better error concealment method. Therefore, the term with D_{ec}(n,m) should be retained. Consequently, the coefficient

$${\prod }_{i = 0}^{n} ( 1 - {p}_{l , i} )$$

that is common only for the first and third item should also be retained.

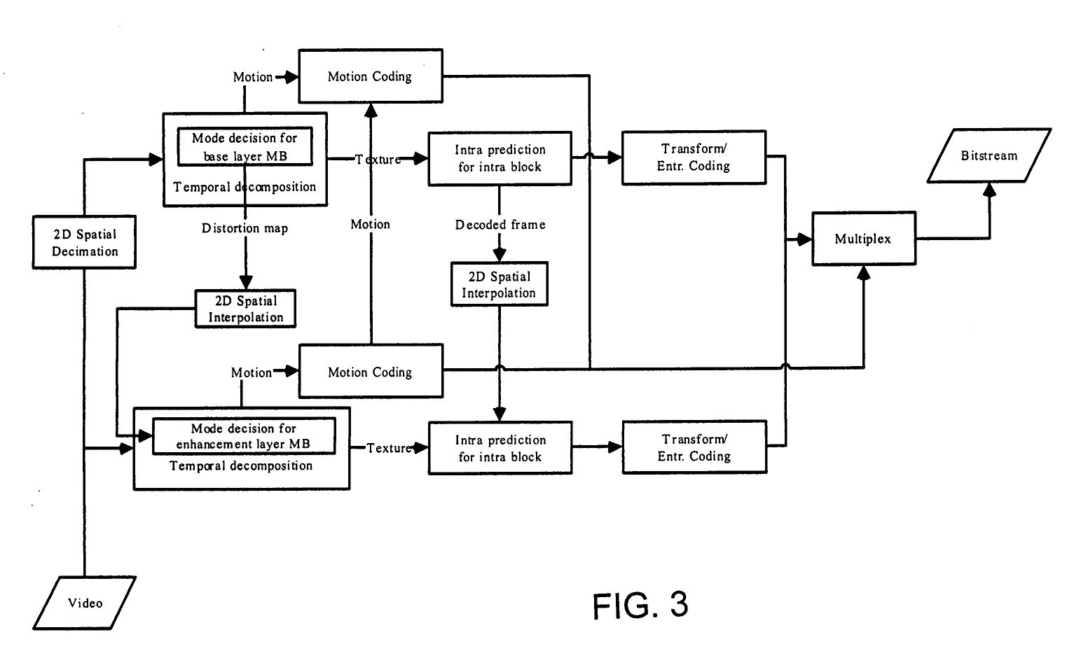

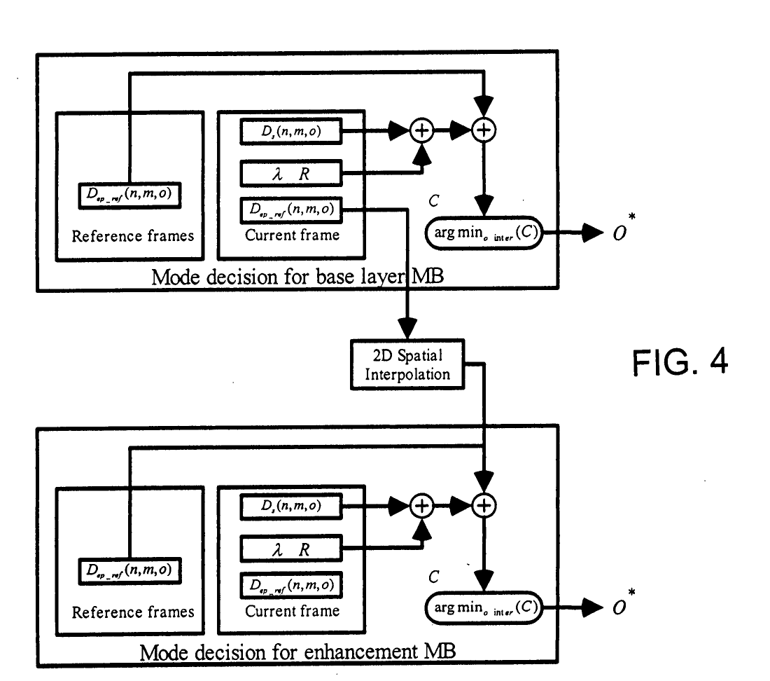

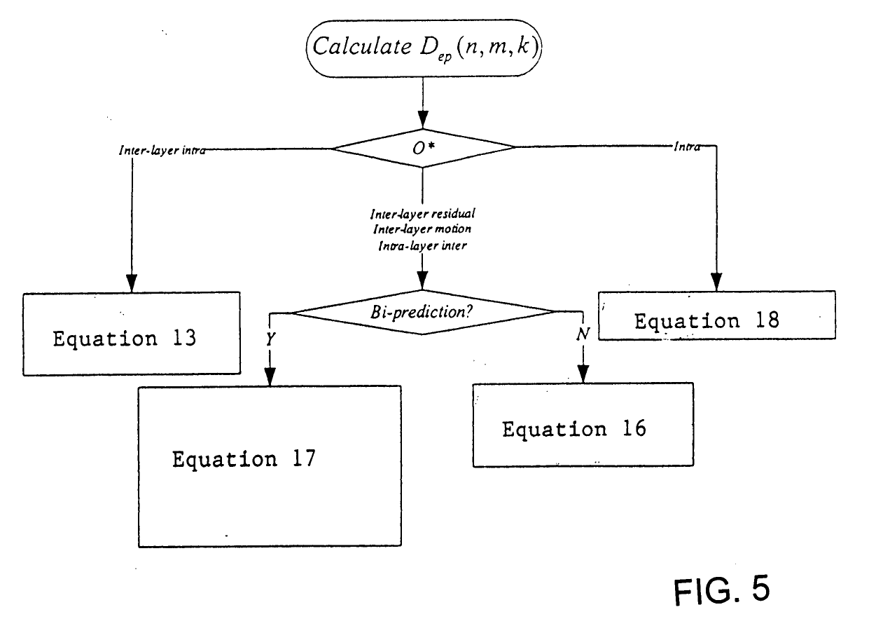

It should be noted that the present invention is applicable to scalable video coding wherein the encoder is configured to estimate the coding distortion affecting the reconstructed segments in macroblock coding modes according to a target channel error rate which is estimated and/or signaled. The encoder also includes a Lagrange multiplier selector based on estimated or signaled channel loss rates for different layers and a mode decision module or algorithm that is arranged to choose the optimal mode based on one or more encoding parameters. FIG. 3 shows the mode decision process which can be incorporated into the current SVC coder structure with a base layer and a spatial enhancement layer. Note that the enhancement layer may have the same spatial resolution as the base layer and there may be more than two layers in a scalable bitstream. The details of the optimized macroblock mode decision process with a base layer and a spatial enhancement layer are shown in FIG. 4. In FIG. 4, C denotes the cost as calculated according to Equation 11 or 21, for example, and the output O* is the optimal coding option that results in the minimal cost and that allows the mode decision algorithm to calculate the distortion map, as shown in FIG. 5.

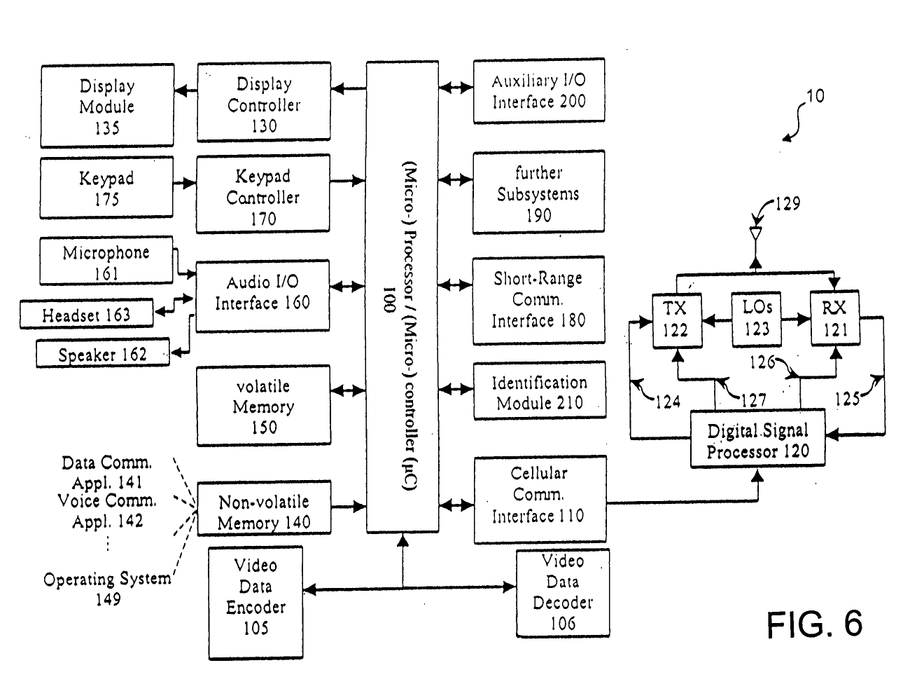

FIG. 6 depicts a typical mobile device according to an embodiment of the present invention. The mobile device 10 shown in FIG. 6 is capable of cellular data and voice communications. It should be noted that the present invention is not limited to this specific embodiment, which represents one of a multiplicity of different embodiments. The mobile device 10 includes a (main) microprocessor or microcontroller 100 as well as components associated with the microprocessor controlling the operation of the mobile device. These components include a display controller 130 connecting to a display module 135, a non-volatile memory 140, a volatile memory 150 such as a random access memory (RAM), an audio input/output (I/O) interface 160 connecting to a microphone 161, a speaker 162 and/or a headset 163, a keypad controller 170 connected to a keypad 175 or keyboard, any auxiliary input/output (I/O) interface 200, and a short-range communications interface 180. Such a device also typically includes other device subsystems shown generally at 190.

The mobile device 10 may communicate over a voice network and/or may likewise communicate over a data network, such as any public land mobile networks (PLMNs) in form of e.g. digital cellular networks, especially GSM (global system for mobile communication) or UMTS (universal mobile telecommunications system). Typically the voice and/or data communication is operated via an air interface, i.e. a cellular communication interface subsystem in cooperation with further components (see above) to a base station (BS) or node B (not shown) being part of a radio access network (RAN) of the infrastructure of the cellular network.

The cellular communication interface subsystem as depicted illustratively in FIG. 6 comprises the cellular interface 110, a digital signal processor (DSP) 120, a receiver (RX) 121, a transmitter (TX) 122, and one or more local oscillators (LOs) 123 and enables the communication with one or more public land mobile networks (PLMNs). The digital signal processor (DSP) 120 sends communication signals 124 to the transmitter (TX) 122 and receives communication signals 125 from the receiver (RX) 121. In addition to processing communication signals, the digital signal processor 120 also provides for the receiver control signals 126 and transmitter control signal 127. For example, besides the modulation and demodulation of the signals to be transmitted and signals received, respectively, the gain levels applied to communication signals in the receiver (RX) 121 and transmitter (TX) 122 may be adaptively controlled through automatic gain control algorithms implemented in the digital signal processor (DSP) 120. Other transceiver control algorithms could also be implemented in the digital signal processor (DSP) 120 in order to provide more sophisticated control of the transceiver 121/122.

In case the mobile device 10 communications through the PLMN occur at a single frequency or a closely-spaced set of frequencies, then a single local oscillator (LO) 123 may be used in conjunction with the transmitter (TX) 122 and receiver (RX) 121. Alternatively, if different frequencies are utilized for voice/data communications or transmission versus reception, then a plurality of local oscillators can be used to generate a plurality of corresponding frequencies.

Although the mobile device 10 depicted in FIG. 6 is used with the antenna 129 as or with a diversity antenna system (not shown), the mobile device 10 could be used with a single antenna structure for signal reception as well as transmission. Information, which includes both voice and data information, is communicated to and from the cellular interface 110 via a data link between the digital signal processor (DSP) 120. The detailed design of the cellular interface 110, such as frequency band, component selection, power level, etc., will be dependent upon the wireless network in which the mobile device 10 is intended to operate.

After any required network registration or activation procedures, which may involve the subscriber identification module (SIM) 210 required for registration in cellular networks, have been completed, the mobile device 10 may then send and receive communication signals, including both voice and data signals, over the wireless network. Signals received by the antenna 129 from the wireless network are routed to the receiver 121, which provides for such operations as signal amplification, frequency down conversion, filtering, channel selection, and analog to digital conversion. Analog to digital conversion of a received signal allows more complex communication functions, such as digital demodulation and decoding, to be performed using the digital signal processor (DSP) 120. In a similar manner, signals to be transmitted to the network are processed, including modulation and encoding, for example, by the digital signal processor (DSP) 120 and are then provided to the transmitter 122 for digital to analog conversion, frequency up conversion, filtering, amplification, and transmission to the wireless network via the antenna 129.

The microprocessor/microcontroller (μC) 110, which may also be designated as a device platform microprocessor, manages the functions of the mobile device 10. Operating system software 149 used by the processor 110 is preferably stored in a persistent store such as the non-volatile memory 140, which may be implemented, for example, as a Flash memory, battery backed-up RAM, any other non-volatile storage technology, or any combination thereof. In addition to the operating system 149, which controls low-level functions as well as (graphical) basic user interface functions of the mobile device 10, the non-volatile memory 140 includes a plurality of high-level software application programs or modules, such as a voice communication software application 142, a data communication software application 141, an organizer module (not shown), or any other type of software module (not shown). These modules are executed by the processor 100 and provide a high-level interface between a user of the mobile device 10 and the mobile device 10. This interface typically includes a graphical component provided through the display 135 controlled by a display controller 130 and input/output components provided through a keypad 175 connected via a keypad controller 170 to the processor 100, an auxiliary input/output (I/O) interface 200, and/or a short-range (SR) communication interface 180. The auxiliary I/O interface 200 comprises especially USB (universal serial bus) interface, serial interface, MMC (multimedia card) interface and related interface technologies/standards, and any other standardized or proprietary data communication bus technology, whereas the short-range communication interface radio frequency (RF) low-power interface includes especially WLAN (wireless local area network) and Bluetooth communication technology or an IRDA (infrared data access) interface. The RF low-power interface technology referred to herein should especially be understood to include any IEEE 801.xx standard technology, which description is obtainable from the Institute of Electrical and Electronics Engineers. Moreover, the auxiliary I/O interface 200 as well as the short-range communication interface 180 may each represent one or more interfaces supporting one or more input/output interface technologies and communication interface technologies, respectively. The operating system, specific device software applications or modules, or parts thereof, may be temporarily loaded into a volatile store 150 such as a random access memory (typically implemented on the basis of DRAM (direct random access memory) technology for faster operation). Moreover, received communication signals may also be temporarily stored to volatile memory 150, before permanently writing them to a file system located in the non-volatile memory 140 or any mass storage preferably detachably connected via the auxiliary I/O interface for storing data. It should be understood that the components described above represent typical components of a traditional mobile device 10 embodied herein in the form of a cellular phone. The present invention is not limited to these specific components and their implementation depicted merely for illustration and for the sake of completeness.

An exemplary software application module of the mobile device 10 is a personal information manager application providing PDA functionality including typically a contact manager, calendar, a task manager, and the like. Such a personal information manager is executed by the processor 100, may have access to the components of the mobile device 10, and may interact with other software application modules. For instance, interaction with the voice communication software application allows for managing phone calls, voice mails, etc., and interaction with the data communication software application enables for managing SMS (soft message service), MMS (multimedia service), e-mail communications and other data transmissions. The non-volatile memory 140 preferably provides a file system to facilitate permanent storage of data items on the device including particularly calendar entries, contacts etc. The ability for data communication with networks, e.g. via the cellular interface, the short-range communication interface, or the auxiliary I/O interface enables upload, download, and synchronization via such networks.

The application modules 141 to 149 represent device functions or software applications that are configured to be executed by the processor 100. In most known mobile devices, a single processor manages and controls the overall operation of the mobile device as well as all device functions and software applications. Such a concept is applicable for today's mobile devices. The implementation of enhanced multimedia functionalities includes, for example, reproducing of video streaming applications, manipulating of digital images, and capturing of video sequences by integrated or detachably connected digital camera functionality. The implementation may also include gaming applications with sophisticated graphics and the necessary computational power. One way to deal with the requirement for computational power, which has been pursued in the past, solves the problem for increasing computational power by implementing powerful and universal processor cores. Another approach for providing computational power is to implement two or more independent processor cores, which is a well known methodology in the art. The advantages of several independent processor cores can be immediately appreciated by those skilled in the art. Whereas a universal processor is designed for carrying out a multiplicity of different tasks without specialization to a pre-selection of distinct tasks, a multi-processor arrangement may include one or more universal processors and one or more specialized processors adapted for processing a predefined set of tasks. Nevertheless, the implementation of several processors within one device, especially a mobile device such as mobile device 10, requires traditionally a complete and sophisticated re-design of the components.

In the following, the present invention will provide a concept which allows simple integration of additional processor cores into an existing processing device implementation enabling the omission of expensive complete and sophisticated redesign. The inventive concept will be described with reference to system-on-a-chip (SoC) design. System-on-a-chip (SoC) is a concept of integrating at least numerous (or all) components of a processing device into a single high-integrated chip. Such a system-on-a-chip can contain digital, analog, mixed-signal, and often radio-frequency functions—all on one chip. A typical processing device comprises a number of integrated circuits that perform different tasks. These integrated circuits may include especially microprocessor, memory, universal asynchronous receiver-transmitters (UARTs), serial/parallel ports, direct memory access (DMA) controllers, and the like. A universal asynchronous receiver-transmitter (UART) translates between parallel bits of data and serial bits. The recent improvements in semiconductor technology cause very-large-scale integration (VLSI) integrated circuits to enable a significant growth in complexity, making it possible to integrate numerous components of a system in a single chip. With reference to FIG. 6, one or more components thereof, e.g. the controllers 130 and 170, the memory components 150 and 140, and one or more of the interfaces 200, 180 and 110, can be integrated together with the processor 100 in a signal chip which forms finally a system-on-a-chip (Soc).

Additionally, the device 10 is equipped with a module for scalable encoding 105 and scalable decoding 106 of video data according to the inventive operation of the present invention. By means of the CPU 100 said modules 105, 106 may individually be used. However, the device 10 is adapted to perform video data encoding or decoding respectively. Said video data may be received by means of the communication modules of the device or it also may be stored within any imaginable storage means within the device 10.

In sum, the present invention provides a method and an encoder for scalable video coding for coding video segments including a plurality of base layer pictures and enhancement layer pictures, wherein each enhancement layer picture comprises a plurality of macroblocks arranged in one or more layers and wherein a plurality of macroblock coding modes are arranged for coding a macroblock in the enhancement layer picture subject to coding distortion. The method comprising estimating the coding distortion affecting reconstructed video segments in different macroblock coding modes, wherein the estimated distortion comprises the distortion at least caused by channel errors that are likely to occur to the video segments; determining a weighting factor for each of said one or more layers; and selecting one of the macroblock coding modes for coding the macroblock based on the estimated coding distortion. The coding distortion is estimated according to a target channel error rate. The target channel error rate includes the estimated channel error rate and the signaled channel error rate. The selection of the macroblock coding mode is determined by the sum of the estimated coding distortion and the estimated coding rate multiplied by the weighting factor. Furthermore, the distortion estimation also includes estimating an error propagation distortion.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A method of scalable video coding for coding video segments including a plurality of base layer pictures and enhancement layer pictures, wherein each enhancement layer picture comprises a plurality of macroblocks arranged in one or more layers and wherein a plurality of macroblock coding modes are arranged for coding a macroblock in the enhancement layer picture subject to coding distortion, said method comprising:
estimating the coding distortion affecting reconstructed video segments in different macroblock coding modes according to a target channel error rate; and
selecting one of the macroblock coding modes for coding the macroblock based on the estimated coding distortion.

2. The method of claim 1, further comprising:
determining a weighting factor for each of said one or more layers, wherein said selecting is also based on an estimated coding rate multiplied by the weighting factor.

3. The method of claim 2, wherein said selecting is determined by a sum of the estimated coding distortion and the estimated coding rate multiplied by the weighting factor.

4. The method of claim 1, wherein said estimating comprises estimating an error propagation distortion.

5. The method of claim 1, wherein said estimating comprises estimating packet losses to the video segments.

6. The method of claim 1, wherein the target channel error rate comprises an estimated channel error rate.

7. The method of claim 1, wherein the target channel error rate comprises a signaled channel error rate.

8. The method of claim 1, wherein the target channel error rate for a scalable layer is different from another scalable layer and wherein said estimating takes into account the different target channel error rates.

9. The method of claim 2, wherein the target channel error rate for a scalable layer is different from another scalable layer and the weighting factor is determined based on the different target channel error rates.

10. The method of claim 4, wherein the target channel error rate for a scalable layer is different from another scalable layer and wherein said estimating of an error propagation distortion is also based on the different target channel error rates.

11. A scalable video encoder for coding video segments including a plurality of base layer pictures and enhancement layer pictures, wherein each enhancement layer picture comprises a plurality of macroblocks arranged in one or more layers and wherein a plurality of macroblock coding modes are arranged for coding a macroblock in the enhancement layer picture subject to coding distortion, said encoder comprising:
a distortion estimator for estimating the coding distortion affecting reconstructed video segments in different macroblock coding modes according to a target channel error rate; and
a mode decision module for selecting one of the macroblock coding modes for coding the macroblock based on the estimated coding distortion.

12. The encoder of claim 11, further comprising:
a weighting factor selector for determining a weighting factor for each of said one or more layers, based on an estimated coding rate multiplied by the weighting factor.

13. The encoder of claim 12, wherein the mode decision module is configured to select the coding mode based on a sum of the estimated coding distortion and the estimated coding rate multiplied by the weighting factor.

14. The encoder of claim 11, wherein the distortion estimator is also configured to estimate an error propagation distortion.

15. The encoder of claim 11, wherein the distortion estimator is also configured to estimate packet losses to the video segments.

16. The encoder of claim 11, wherein the distortion estimator is also configured to estimate the target channel error rate based on an estimated channel error rate.

17. The encoder of claim 11, wherein the distortion estimator is also configured to estimate the target channel error rate based on a signaled channel error rate.

18. The encoder of claim 11, wherein the target channel error rate for a scalable layer is different from another scalable layer and wherein the distortion estimator is configured to take into account the different target channel error rates.

19. The encoder of claim 12, wherein the target channel error rate for a scalable layer is different from another scalable layer and wherein the weighting factor selector is configured to select the weighting factor based on the different target channel error rates.

20. The encoder of claim 14, wherein the target channel error rate for a scalable layer is different from another scalable layer and wherein the distortion estimator is configured to estimate the error propagation distortion based on the different target channel error rates.

21. A software application product comprising a computer readable storage medium having a software application for use in scalable video coding for coding video segments including a plurality of base layer pictures and enhancement layer pictures, wherein each enhancement layer picture comprises a plurality of macroblocks arranged in one or more layers and wherein a plurality of macroblock coding modes are arranged for coding a macroblock in the enhancement layer picture subject to coding distortion, said software application comprising:
programming code for estimating the coding distortion affecting reconstructed video segments in different macroblock coding modes according to a target channel error rate;
programming code for determining a weighting factor for each of said one or more layers, wherein said selecting is also based on an estimated coding rate multiplied by the weighting factor; and
programming code for selecting one of the macroblock coding modes for coding the macroblock based on the estimated coding distortion.

22. The software application product of claim 21, wherein the programming code for selecting the coding mode is based on a sum of the estimated coding distortion and the estimated coding rate multiplied by the weighting factor.

23. The method of claim 1, wherein said estimating comprises estimating an error propagation distortion.

24. A video coding apparatus comprising an encoder according to claim 11.

25. An electronic device comprising an encoder according to claim 11.

26. The electronic device of claim 25, comprising a mobile terminal.
